(19) United States
(12) Patent Application Publication
(10) Pub. No.: US 2010/0002464 A1
(43) Pub. Date: Jan. 7, 2010

(54) LIGHT EMITTING DIODE LAMP

(75) Inventor: CHIA-SHOU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/195,397

(22) Filed: Aug. 20, 2008

(30) Foreign Application Priority Data
Jul. 4, 2008 (CN) 200810068326.2

(51) Int. Cl. F21V 7/04; F21S 8/00

(52) U.S. Cl. 362/612

(57) ABSTRACT

An exemplary light emitting diode (LED) lamp includes a substrate, a plurality of LED chips mounted on the substrate, a lens, and a plurality of reflecting layers. The lens, above the LED chips, has a plurality of first protruding strips and a second protruding strip on a top thereof. Each of the first protruding strips includes a side surface angled with respect to the substrate and a vertical side surface perpendicular to the substrate. The second protruding strip includes two side surfaces, each angled with respect to the substrate. The reflecting layers are formed on the angled side surfaces of the first protruding strips and the second protruding strip, respectively.

### BACKGROUND

1. Field of the Invention

The present invention relates to a light emitting diode lamp.

2. Description of Related Art

Currently, LEDs (light emitting diode) are preferred for use in non-emissive display devices rather than CCFLs (cold cathode fluorescent lamp) due to their high brightness, long lifespan, and wide color range.

Referring to FIG. 2, a LED lamp includes a substrate 101, a plurality of LED chips 102 disposed on the substrate 101, a cowling 104 mounted on the substrate 101 enclosing the LED chips 102 therein, and a lens 106 on the cowling 104. The lens 106 is a convex lens having a convex top surface facing the surrounding environment of the LED lamp.

During operation, the LED chips 102 emit light upon receiving an electrical current, and the light leaves the LED lamp through the lens 106. It is known that the majority of light from each of the LED chips 102 travels approximately perpendicular to the chip surface and is focused by the lens 106. Thus, the majority of the light emitted from each of the LED chips 102 leaves the LED lamp from the lens 106 as a beam, which causes a periphery of the lens 106 to be darker than a central area thereof, preventing uniform distribution of light from the LED lamp.

It is thus desired to provide a LED lamp which can overcome the described limitations.

### SUMMARY

The present invention relates to a light emitting diode lamp. According to an exemplary embodiment of the present invention, the light emitting diode lamp includes a substrate, a plurality of light emitting diode chips mounted on the substrate, a lens and a plurality of reflecting layers. The lens is located above the light emitting diode chips. The lens forms a plurality of first protruding strips and a second protruding strip on a top surface thereof. Each of the first protruding strips includes an angled side surface angled with respect to the substrate and a vertical side surface perpendicular to the substrate. The second protruding strip includes two side surfaces, each of which is angled with respect to the substrate. The reflecting layers are formed on the angled side surfaces of the first protruding strips and the second protruding strip, respectively.

Other advantages and novel features of the present invention will become more apparent from the following detailed description of embodiment when taken in conjunction with the accompanying drawings.

### BRIEF DESCRIPTION OF THE DRAWINGS

FIG. 1 is a cross-section of a light emitting diode lamp in accordance with an exemplary embodiment of the present invention.

FIG. 2 is a cross-section of a light emitting diode lamp according to the related art.

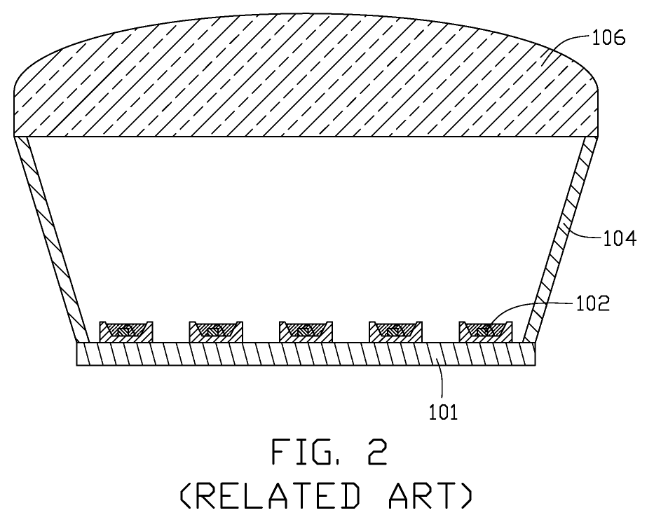

### DETAILED DESCRIPTION OF THE EMBODIMENTS

Reference will now be made to the drawings to describe the various present embodiments in detail.

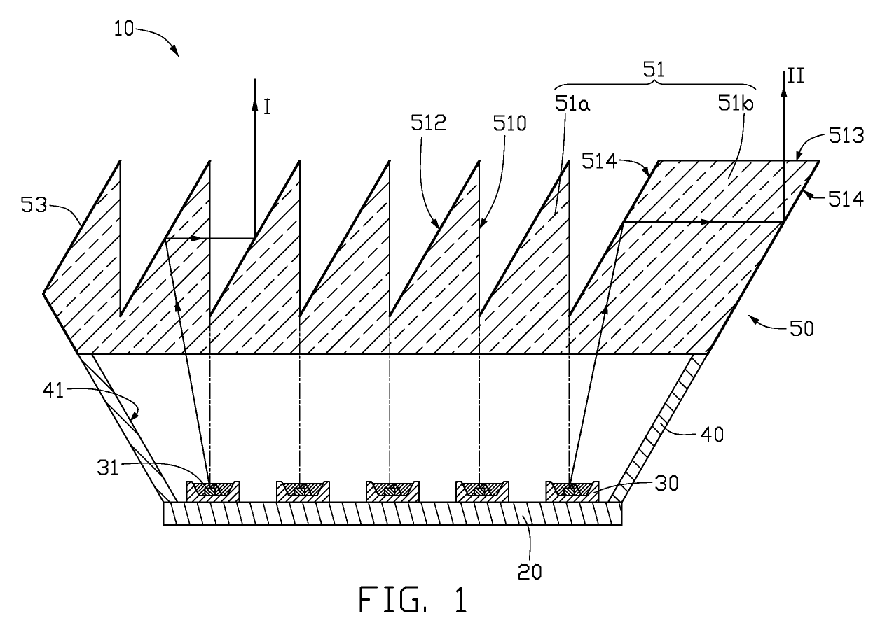

Referring to FIG. 1, a light emitting diode (LED) lamp 10 according to an exemplary embodiment of the present invention includes a substrate 20, a LED array 30, a cowling 40 and a lens 50.

The substrate 20, having electrical and thermal conductivities, is planar and supports the LED array 30, the cowling 40 and the lens 50 thereon.

The LED array 30 includes a plurality of LED chips 31 arranged in a matrix on a top surface of the substrate 20. The matrix consists of five lines of LED chips 31, arrayed along a first axis of the substrate 20, and five rows of LED chips 31 arrayed along a second axis of the substrate 20, although only one row of LED chips 31 is shown in FIG. 1.

The cowling 40, of materials having high reflectivity, is substantially a frustum of an inverted cone with open top and bottom ends. A cross-section of the cowling 40 constitutes two lateral sides 41 angled with respect to the top surface of the substrate 20. The bottom of the cowling 40 connects with the substrate 20. The cowling 40 and the substrate 20 cooperatively form a receiving space (not labeled) enclosing the LED array 30.

The lens 50, covering the top end of the cowling 40, is of transparent, light permeable material such as epoxy resin, glass or other. In this embodiment, the lens 50 is glass, providing resistance to high temperature, erosion, scratches and other potential damage. The lens 50 has a planar bottom surface parallel to the top surface of the substrate 20 and an opposite top surface. A plurality of longitudinal protrusions 51 protrude upwardly from the top surface of the lens 50, along the first axis of the substrate 20. The protrusions 51 include a plurality of parallel first protruding strips 51a abutting each other, and a second protruding strip 51b located on one side of the first protruding strips 51a.

Each of the first protruding strips 51a includes a side surface 512 angled with respect to the top surface of the substrate 20, and a vertical side surface 510 perpendicular to the top surface of the substrate 20. The vertical side surface 510 of each of the first protruding strips 51a is to the right of the first protruding strip 51a, and the angled side surface 512 of each of the first protrusions 51a is to the left of the first protruding strip 51a. The vertical side surface 510 of each of the first protruding strips 51a intersects the angled side surface 512 of the first protruding strip 51a at a top end thereof. An acute angle is formed between the angled side surface 512 of each of the first protruding strips 51a and the top surface of the substrate 20. A cross-section of each of the first protruding strips 51a is right triangular.

The second protruding strip 51b is to the right of the rightmost first protruding strip 51a. The second protruding strip 51b includes two side surfaces 514, angled with respect to the top surface of the substrate 20 respectively, and a horizontal top surface 513 parallel to the top surface of the substrate 20. The horizontal top surface 513 connects the top ends of the two angled side surfaces 514. A cross-section of each of the second protruding strips 51b is a parallelogram. The angled side surfaces 514 of the second protruding strip 51b are parallel, as are each of the angled side surfaces 514 of the second protruding strip 51b with the angled side surface 512 of each of the first protruding strips 51a. The vertical side surface 510 of each of the first protruding strips 51a intersects a neighboring angled side surface 512, 514, which is to the right of the vertical side surface 510 of the first protruding strip 51a, at a bottom end thereof.

A plurality of reflecting layers 53 are formed on the angled side surfaces 512, 514 of the first protruding strips 51a and the second protruding strip 51b, respectively. Each of the reflecting layers 53 is of reflective material such as metallic coating.

Each respective line of the LED chips 31 is located just under a respectively vertical side surface 510 of the first protruding strips 51a. In this embodiment, the lens 50 includes six first protruding strips 51a, with the five lines of the LED chips 31 under the corresponding vertical side surfaces 510 thereof. A central axis of light of each LED chip 31 is in line with the vertical side surface 510 of the corresponding first protruding strip 51a.

In operation, part of the light emitted from the LED chips 31 is emitted directly towards the top end of the lens 50, and leaves the LED lamp 10 therefrom. The other part of light from the LED chips 31 is emitted first toward an internal side surface of the cowling 40, and then reflected by the cowling 40 to the top end of the lens 50, finally exiting the LED lamp 10 therefrom.

Since the first protruding strips 51a and the second protruding strip 51b are formed on the top surface of the lens 50, and the reflecting layers 53 are formed on the angled side surfaces 512, 514 of the first protruding strips 51a and the second protruding strip 51b respectively, light is transmitted through the lens 50 along two paths, i.e., path I and path II of FIG. 1. As shown in path I, the light is first emitted towards the angled side surfaces 512 of the first protruding strips 51a, then reflected by the reflecting layers 53 and continues to the vertical side surfaces 510, further being reflected by the reflecting layers 53 of the neighboring first or second protruding strips 51a, 51b and is emitted upward and to the exterior of the LED lamp 10. As shown in path II, the other portion of the light is emitted towards one of the angled side surfaces 514 of the second protruding strip 51b, then reflected by the reflecting layer 53 thereof and to the other angled side surface 514, and further reflected by the reflecting layer 53 of the other angled side surface 514 upwardly to the exterior of the LED lamp 10. Accordingly, the light is uniformly emitted by the LED lamp 10 through the lens 50, in substantially parallel directions.

It is to be understood that even though numerous characteristics and advantages of the present invention have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light emitting diode lamp comprising:
a substrate;
a plurality of light emitting diode chips mounted on the substrate;
a lens located above the light emitting diode chips, the lens forming a plurality of first protruding strips and a second protruding strip on a top surface thereof, each of the first protruding strips comprising a side surface angled with respect to the substrate and a vertical side surface perpendicular to the substrate, the second protruding strip comprising two side surfaces, each of which is angled with respect to the substrate; and
a plurality of reflecting layers on the angled side surfaces of the first protruding strips and the second protruding strip, respectively.

2. The light emitting diode lamp of claim 1, wherein the angled side surfaces of the first protruding strips and the angled side surfaces of the second protruding strip are parallel.

3. The light emitting diode lamp of claim 1, wherein the angled side surface and the vertical side surface of each of the first protruding strips intersect at a top end of the first protruding strip, and the vertical side surface of each of the first protruding strips intersects the angled side surface of a neighboring first or second protruding strip at a bottom end of the first protruding strip.

4. The light emitting diode lamp of claim 3, wherein a cross-section of each of the first protruding strip is right triangular.

5. The light emitting diode lamp of claim 2, wherein the second protruding strip comprises a horizontal top surface parallel to the substrate connecting top ends of the two angled side surfaces of the second protruding strip.

6. The light emitting diode lamp of claim 5, wherein a cross-section of the second protruding strip is a parallelogram.

7. The light emitting diode lamp of claim 1, wherein each of the first protruding strips and the second protruding strip extend along a first axis of the substrate, the light emitting diode chips comprise a plurality of lines of the light emitting diode chips, and each respective line of the light emitting diode chips is located under a respectively vertical side surface of the corresponding first protruding strip.

8. The light emitting diode lamp of claim 1, further comprising a cowling mounted on the substrate enclosing the light emitting diode chips therein, substantially comprising a frustum of an inverted cone, the lens covering a top end of the cowling.

9. The light emitting diode lamp of claim 1, wherein a portion of light from the light emitting diode chips is first emitted towards the angled side surfaces of the first protruding strips, then reflected by the reflecting layer and emitted through the vertical side surfaces, and further reflected by the reflecting layers of a neighboring first or second protruding strip, and is emitted upwardly to the exterior of the light emitting diode lamp.

10. The light emitting diode lamp of claim 1, wherein a portion of light emitted from the light emitting diode chips is first emitted towards one of the angled side surfaces of the second protruding strip, then reflected by the reflecting layer thereof, is emitted toward the other angled side surface, and is further reflected by the reflecting layer of the other angled side surfaces to be emitted upwardly to the exterior of the light emitting diode lamp.

11. A light emitting diode lamp comprising:
a substrate;
a plurality of light emitting diode chips mounted on the substrate;
a cowling mounted on the substrate enclosing the light emitting diode chips therein;
a lens covering a top end of the cowling, comprising a plurality of protrusions formed on a top surface thereof, each comprising a side surface angled with respect to the substrate and a vertical side surface perpendicular thereto, wherein the light emitting diode chips are under the vertical side surfaces of the protrusions; and
a plurality of reflecting layers are disposed on the angled side surfaces of the protrusions, respectively.

12. The light emitting diode lamp of claim 11, wherein a cross-section of each of the protrusions is a right triangular.

13. The light emitting diode lamp of claim 11, wherein the lens further comprises another protrusion on one side of the protrusions, and a cross-section of the another protrusion is a parallelogram.

14. The light emitting diode lamp of claim 13, wherein the another protrusion comprises two side surfaces angled with respect to the substrate respectively, and a horizontal top surface parallel to the substrate, the horizontal top surface of the other protrusion connected between top ends of the two angled side surfaces.

15. A light emitting diode lamp comprising:
a substrate;
a plurality of light emitting diode chips mounted on the substrate;
a cowling mounted on the substrate and surrounding the light emitting chips;
a lens mounted on the cowling, a top of the lens forming a plurality inclined side surfaces each angled with respect to the substrate and a plurality of vertical side surfaces each being perpendicular to the substrate, the inclined side surfaces being alternate with the vertical side surfaces; and
a plurality of reflecting layers on the inclined side surfaces of the top of the lens, respectively, the vertical side surfaces each being without a reflecting layer thereon.

16. The light emitting diode lamp of claim 15, wherein the vertical side surfaces are in line with the light emitting diode chips.

17. The light emitting diode lamp of claim 15, wherein each of the inclined side surfaces intersects a corresponding neighboring vertical side surface at the top of the lens with an acute angle defined therebetween.

18. The light emitting diode lamp of claim 16, wherein each of the inclined side surfaces intersects a corresponding neighboring vertical side surface at the top of the lens with an acute angle defined therebetween.
